(19) United States
(12) Patent Application Publication
(10) Pub. No.: US 2025/0191333 A1
(43) Pub. Date: Jun. 12, 2025

(54) SYSTEM FOR MULTI-COLOR PRODUCT REPRESENTATION VIA PART-WISE COLOR EXTRACTION AND METHOD THEREOF

(71) Applicant: Course5 Intelligence Limited, Mumbai (IN)

(72) Inventors: Sujith Rejith KUMAR, Mumbai (IN); Jayachandran Kizhakoot RAMACHANDRAN, Mumbai (IN); Soviek SAURAV, Mumbai (IN)

(21) Appl. No.: 18/623,071

(22) Filed: Apr. 1, 2024

(30) Foreign Application Priority Data
Dec. 8, 2023 (IN) 202321083903

(51) Int. Cl. G06V 10/56; G06F 16/583; G06V 10/22; G06V 10/26; G06V 10/74; G06V 10/75

(52) U.S. Cl. CPC G06V 10/56; G06F 16/5838; G06V 10/225; G06V 10/273; G06V 10/751; G06V 10/761

(57) ABSTRACT

The present invention discloses a system for multi-color product representation through part-wise color extraction and corresponding method. The system (100) includes an image retrieval module (101) for fetching product images, a product identification module (102) using deep learning model engines to isolate product pixels, a part identification module (103) for distinguishing product parts, a color extraction module (104) for computing color percentages with a set color palette, and a color representation module (105) for creating a two-dimensional color vector. Finally, a color matching module (106) ensures precise product color comparisons using the color vector distance measurement between products.

### PREAMBLE TO THE DESCRIPTION

The following specification describes the invention and the manner in which it is to be performed:

### DESCRIPTION OF THE INVENTION

### Technical Field of the Invention

The present invention relates to the field of image processing and, more specifically, to a system for extracting color data from different parts of images of products and the corresponding method. The invention involves the use of deep learning model engines and image analysis techniques to identify and segregate product pixels, differentiate product parts, and precisely extract and quantify color information.

### Background of the Invention

The utility of image analysis is vast and critical across multiple fields, including recommendation systems, analytics of product features, and visual-based product searches. A key element of the image analysis is the extraction of colors which serves as a fundamental tool for recognizing and understanding the visual properties of different products. Traditional color extraction methods typically depend on textual color descriptions or implement color histograms that analyze the image as a whole.

Relying on textual color descriptions can lead to inaccuracies and inefficiencies due to the lack of descriptions or discrepancies between described and actual colors in images. Likewise, color histograms or global color clustering that do not isolate the colors of individual parts of a product, often result in a flawed and imprecise representation of the product's color features, negatively impacting the functionality of recommendation engines, analytical tools, and product search methodologies.

With the growth of the e-commerce, there is an evident gap between consumer expectations for precise product discovery and the capabilities of existing search technologies. Current keyword and picture recognition algorithms fall short in bridging the gap that occurs when online buyers try to find products that fit specified color criteria.

The Patent Application No. US20160117572A1 entitled “Extraction of image feature data from images” discloses an apparatus and method for obtaining image feature data from an image. The process involves extracting a color histogram from the image, which includes one-dimensional sampling of pixels within the image along each of the first, second, and third dimensions of a color space. Additionally, the application involves analyzing an edge map corresponding to the image to detect patterns present within it. If the confidence level of the pattern detection falls below a pre-defined threshold, the method further includes extracting an orientation histogram from the image. The approach is particularly useful in identifying a dominant color and key visual elements within an image, as the invention primarily captures a holistic, singular view of the color distribution rather than detailed, part-specific color information.

The Patent Application No. CN110399887A entitled “Representative color extraction method based on visual saliency and histogram statistics technology” discloses a method for extracting representative colors based on visual saliency and histogram statistics technology, within the field of color processing. The approach focuses on regional natural representative color extraction. The invention involves RGB-YUV color space conversion using big data technology, visual saliency extraction, and color histogram series methods. It simplifies the addition of new picture materials to a library and improves efficiency by eliminating the need for recalculating all data. However, the invention centers on broader color representations rather than detailed, segmented color analysis.

The current state of the art technologies primarily concentrates on overall color patterns and dominant color identification in images. They do not explicitly address the need for part-wise or component-specific color analysis in products, which is crucial for applications requiring detailed and accurate color representation of each distinct part of a product. The gap suggests the necessity for a more granular approach to color extraction, where each component of a product is individually analyzed for its color characteristics to provide a comprehensive color profile, rather than focusing solely on overarching color patterns or dominant colors in the entire image.

Hence, there exists a need for an innovative approach that can accurately dissect and interpret the nuanced color compositions of multiple products, revolutionizing the searching experience by ensuring more precise search returns while also markedly boosting user contentment by matching search results with the specific color desires, thereby enhancing user satisfaction by filtering out irrelevant results while improving the efficiency and accuracy of online product categorization and recommendation systems.

### SUMMARY OF THE INVENTION

In order to overcome the drawbacks of the state of the art, the present invention provides a novel approach of color extraction that precisely identifies and segregates colors of different parts of a product in an image. Leveraging the advanced deep learning model engine for the product and part identification, the system compares pixel colors against a predefined color palette, producing a detailed color profile for each part.

The system comprises a plurality of modules, each designed for distinct functionalities. Initially, the image retrieval module collects product images and pertinent details from data repositories and prepares the image for further analysis by adjusting its color space and format. Following this, a product identification module isolates pixels pertaining to the product, and a part identification module assigns the pixels to specific product parts for targeted color extraction. The color extraction module matches the pixel colors to a predefined palette, calculating the color composition of each part. The data is organized into a two-dimensional vector by the color representation module, which correlates product parts with palette colors to create a query color matrix. Finally, the color matching module compares the query color matrix with the color matrices of various products from the repository to find the best matches for the product search.

The method for multi-color product representation via part-wise color extraction initiates with the retrieval of a product image and associated data from a repository, internal storage, or database via an image retrieval module. Product pixels are then extracted from the image using a product identification module, which employs either a trained deep learning model or a prompt-based model.

Following this, a part identification module delineates different parts of the product by mapping each pixel to its corresponding part. The color extraction module subsequently matches the colors present in the product parts with a pre-established color palette and computes the percentage of each color within these individual parts. A color representation module then creates a two-dimensional color matrix for each product part, encapsulating the color percentages corresponding to each palette color, thus illustrating the color distribution across the product parts. Finally, a color matching module compares the extracted color data against an extensive color database, aiming to identify the closest matching colors for the different parts of the product.

A key aspect of the method is the two-dimensional color representation matrix, which is crucial for its precision in analysis and serves as an integral part of search and recommendation processes.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram of a system for multi-color product representation via part-wise color extraction, according to an embodiment of the invention.

FIG. 2 illustrates a flow chart of a method for multi-color product representation via part-wise color extraction, according to an embodiment of the invention.

FIG. 3 illustrates a flow diagram of a process for multi-color product representation via part-wise color extraction, according to an embodiment of the invention.

FIG. 4 depicts an exemplary structure of a color matrix used for the color representation, according to an embodiment of the invention.

FIG. 5 illustrates a flow diagram of the process explaining a query phase for color comparison, according to an embodiment of the invention.

FIG. 6 depicts an exemplary line diagram of rectangular sampling method used by the product identification module.

FIG. 7 depicts an exemplary line diagram of different parts of a sample image as identified by the part identification module.

FIG. 8 depicts an exemplary image of retrieval result for an existing system.

FIG. 9 depicts an exemplary image of retrieval result for the proposed system.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope, and contemplation of the invention.

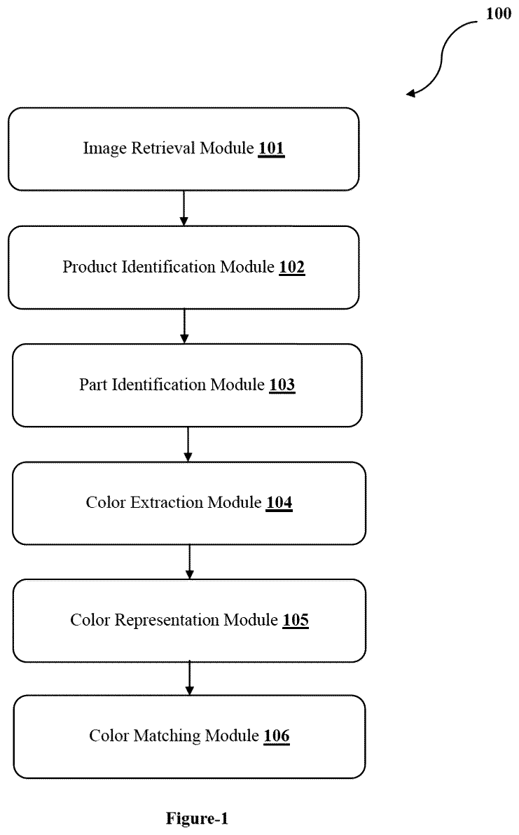

FIG. 1 illustrates a block diagram of a system for multi-color product representation via part-wise color extraction according to an embodiment of the invention. The system (100) comprises an image retrieval module (101) dedicated in securing a broad range of associated product information and textual descriptions comprising product titles, comprehensive details, and notes regarding various product segments or elements, along with the visual data. The image retrieval module (101) is further responsible for identifying the specific sections of the product that require individual color analyses, based on variations in material composition or visible boundaries necessary for color differentiation by human evaluators. Moreover, the image retrieval module (101) executes necessary image transformations, which include modifying the color space to conform to specific standards including Red-Blue-Green (RGB), and altering the image scale or format, thus preparing the visual data for subsequent processing stages.

The product identification module (102) operates on the retrieved image to discern and segregate product pixels for further processing. Utilizing data from the image retrieval module (101), the product identification module (102) selects a user-defined deep-learning model or a prompt-based deep learning model for pixel classification, determining the pixels constituting the product. By doing so, it effectively excludes irrelevant background pixels, ensuring that only product pixels are considered for the color extraction.

The part identification module (103) is engaged to discern individual parts of the product as per the defined parts retrieved from the image retrieval module (101). The part identification module (103) assigns pixels to specific product parts based on a trained deep learning model that are part of the system's comprehensive suite, enabling detailed color extraction for each individual part.

The color extraction module (104) is configured to identify the specific color of each part using a predefined color palette. The palette is a curated selection of colors linked to the product, and the color extraction module (104) compares color of each pixel against the palette to ascertain the color composition of each part. The process involves matching each pixel to the closest color in the palette, using distance metrics like Euclidean or absolute distance. The process in-effective facilitates the grouping of pixels based on color distance for each part of the product.

The quantified colors are then arrayed by the color representation module (105) into a two-dimensional vector space for each product part. The vector space is organized such that one axis represents the product parts, while the other corresponds to the spectrum of the predefined color palette, enabling a systematic representation of the product's color composition.

Finally, the color matching module (106) utilizes the established two-dimensional color vectors to facilitate comparative analysis among multiple products. It computes the similarity between products by evaluating the vector distances within the color representation matrices, leveraging various established metrics to gauge color similarity with precision.

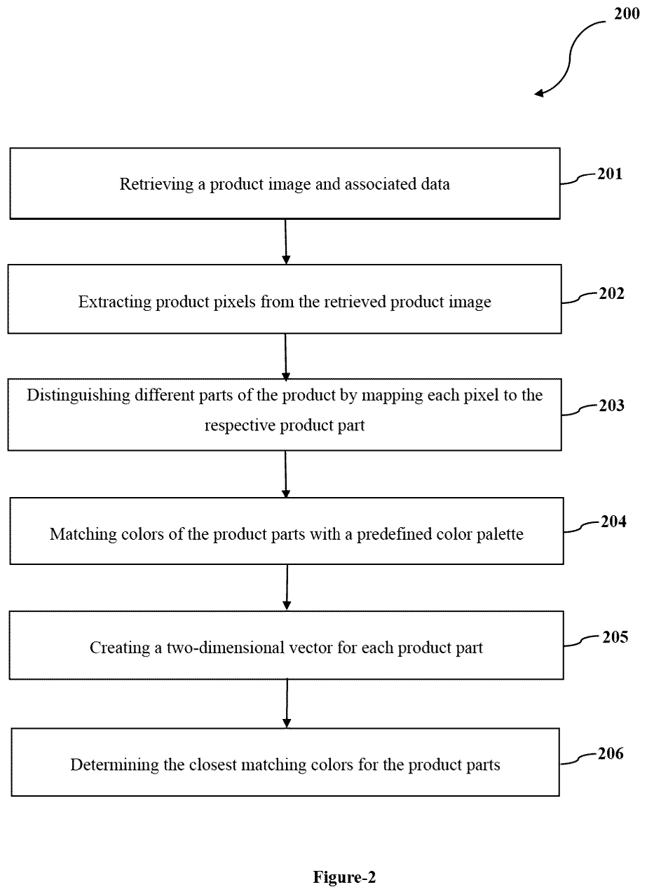

FIG. 2 illustrates a flow chart of a method for multi-color product representation via part-wise color extraction according to an embodiment of the invention. The method (200) comprises the steps of retrieving a product image and associated data from a repository, an internal storage, or a database using an image retrieval module in step (201). Moving to step (202), product pixels are extracted from the procured image by a product identification module, leveraging either a trained deep learning model or a prompt-based model. Step (203) involves the part identification module, which is responsible for delineating different parts of the product. This is achieved by mapping each pixel to its corresponding part of the product. Next, in step (204), the color extraction module takes over, where it matches the colors present in the product parts with a pre-established color palette and computes the percentage of each color within the individual parts. Upon the completion of color matching, step (205) engages a color representation module to create a two-dimensional vector for each part of the product. This vector embodies the color percentages pertaining to each color in the palette, effectively illustrating the color distribution across the product parts. Lastly, in step (206), a color matching module compares the extracted color data against an extensive color database. The comparison aims to pinpoint the closest matching colors for the different parts of the product, employing the color representation data. Collectively, method (200) culminates in an augmented level of precision for color comparisons, facilitating a detailed analysis and ensuring precise color identification within the product image.

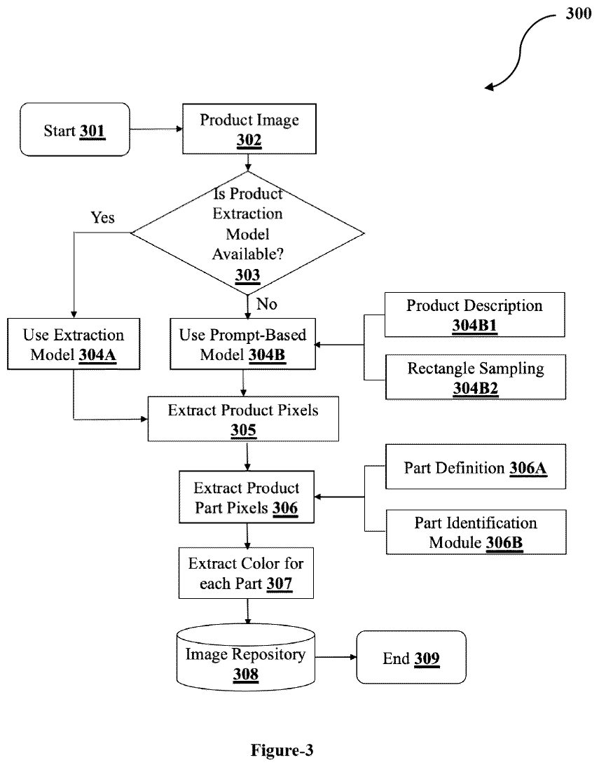

FIG. 3 illustrates a flow diagram of a process for multi-color product representation via part-wise color extraction according to an embodiment of the invention. The process (300) begins with a start node (301) and illustrates the indexing stage wherein color information is extracted from each product and preserved within a repository for subsequent color comparison purposes. The system retrieves each product image (302) that is subject to color analysis, accompanied by details and part information pertaining to the product. Typically, product images are composed with the product centrally located, occupying a majority of the image area.

The initial phase of the system's operation involves the extraction of product-specific pixels from the image. Accompanying data retrieved from the repository indicates whether there is availability of an associated trained deep learning model for pixel extraction purposes of the product (303). The model may either be a direct extraction model (304A) capable of receiving an image as input and extracting product pixels directly from said image, or it could be a prompt-based model (304B). In the prompt-based approach, the prompts might consist of a textual description (304B1) or a rectangular region (304B2) delineated by the output from another localization model.

Upon the availability of a direct extraction model (304A) for the extraction of product pixels, the process (300) engages the direct extraction model (304A) to segregate the pixels pertaining to the product within the image (305). The extraction process adjudicates each pixel, marking its association with the product. In the absence of a direct extraction model, should a prompt-based model (304B) be accessible, the process (300) defaults to the alternative for the pixel extraction operation (305). The presence of either model type is ascertained through data acquired from the image repository, which includes detailed product information. Models designated for product pixel extraction are discerned based on the criterion of a trained model's accuracy surpassing a predetermined threshold.

The term ‘prompt’ of prompt-based model (304B) denotes supplementary data, apart from the product image, that assists the model in executing the designated task. During the pixel extraction procedure (305), prompts may include textual descriptors of the image, encompassing the product's name or detailed description. Additionally, prompts can emanate from the outputs of alternative deep learning models specializing in product localization, which delineate a rectangular region within the image to isolate the product's position. The selection of a prompt-based model for deployment is contingent upon the existence of a model with proven efficacy, as determined by its accuracy exceeding a defined benchmark for the product subject to the pixel extraction endeavor.

In absence of a prompt-based model with requisite accuracy, the system employs a rectangular region sampling (304B2) technique to contrive a prompt. The approach involves formulating a rectangle predicated on the dimensions of the image, intended to encompass the product therein. The dimensions of the stipulated rectangle are proportionally smaller than the products, diminished by a predetermined percentage. The percentage is adaptable, permitting the alteration of the rectangle's size in accordance with the extent of the product's presence in the image. The configured rectangle is then furnished to the prompt-based model that is compatible with rectangular regions as prompts for the pixel extraction task. The methodology assumes that the pixels belonging to the product cover the central portion of the whole image, as commonly seen in e-commerce images. This technique is applicable to a wide range of product images that fulfill the criteria of centrally located coverage, including those from e-commerce platforms.

Upon extraction of pixels pertaining to the product within an image, a part identification module (306B) is employed to segregate the extracted pixels relative to the parts (306) of the product to which they pertain. For each item, the specific part to be discerned and the appropriate deep learning model for identification are sourced from the image retrieval module. The process of part identification involves assigning each pixel to a specific part of the product, in accordance with the definitions (306A) stored within the product repository. The identification of parts is executed utilizing either a deep learning-based segmentation model or a prompt-based model, contingent upon their availability and relevance to the task.

The process of color extraction (307) for each part involves computing the distance between the color of each pixel within that part and every color within a predefined color palette. The closest matching color from the palette is assigned to each pixel based on the minimal distance criterion. This method is systematically applied to all pixels comprising the part, and the colors thus identified are aggregated to define the overall color representation of that part.

Subsequently, for each part, a percentage for each color in the palette is calculated, which quantifies the proportion of pixels exhibiting that color relative to the total pixel count of the part.

Upon establishing the color distribution with associated percentages for each part, a two-dimensional matrix is constructed to encapsulate the color profile of the product. The matrix serves as a color representation, effectively capturing the color distribution across the different components of the product. The extracted colors are then stored within an image repository (308), completing the extraction phase. The process (300) concludes with the end node (309).

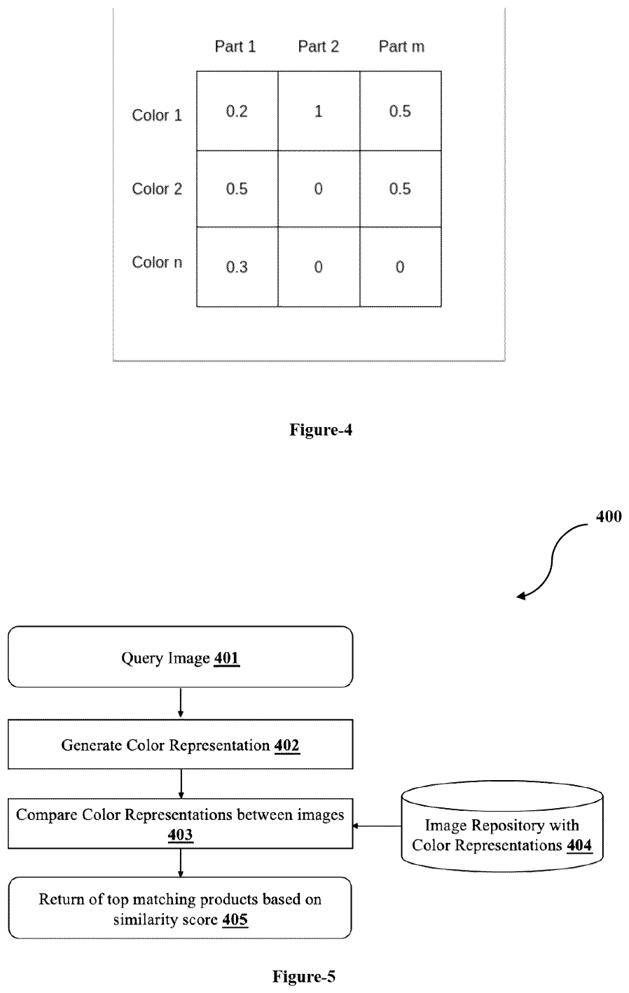

FIG. 4 depicts an exemplary structure of a color matrix used for the color representation according to an embodiment of the invention. The matrix is constructed with rows corresponding to a predefined set of colors and columns designated for discrete parts of a product. Each cell within the matrix quantifies the proportion of the corresponding color present in a given part, with values ranging from 0 to 1, representing a percentage from 0% to 100%. The structure facilitates an accurate and efficient means of encoding the color distribution of the product into a numerical format, which is especially conducive for computational processing in image retrieval systems. By comparing the encoded color representations, the system can effectively match or search for products with specific color criteria across their constituent parts. The representation is instrumental in various applications such as search engines, analytics platforms, recommendation systems, and other image-based retrieval and categorization tools.

FIG. 5 illustrates a flow diagram of the process explaining the query phase for color comparison according to an embodiment of the invention. The process (400) begins with the input of a query image (401). The system then generates color representation for the query image (402), which involves analyzing the image and determining the color composition. Next, this color representation is compared (403) with those in an image repository (404) with color representation which contains a pre-processed dataset of images with their color representations. The final step is to return the top matching products (405) based on similarity score, where the system presents the user with images from the repository that most closely match the query image's color profile.

The following example is offered to illustrate the aspect of the invention. However, the example is not intended to limit or define the scope of the invention in any manner.

### Example 1: A Color-Based Footwear Search on E-Commerce Platforms

In an example, a user seeks shoes characterized by a distinct color pattern: black shoe with white laces and white soles. Based on the color profile, the system constructs a query color matrix to represent part-wise color percentage of various segments of the shoe including the body parts, lacing, and sole areas as requested by the user.

With the query color matrix established, the matrix acts as the reference point for searches within an extensive image database containing numerous shoe images, each having its distinctive query color matrices. An algorithm for assessing similarity is utilized in the process, measuring the correspondence between the user's query color matrix and those stored in the database.

The system runs each database image through the algorithm that calculates how similar the color matrices are to that of the query color matrix. For the similarity measurements, a vector distance measurement algorithm is used including the Euclidean distance and the cosine similarity.

Upon evaluating all possible matches, the system organizes the data by similarity scores, presenting the user with a curated selection of shoes that best align with their choice of specified color scheme. The user-centric result streamlines the shopping experience by providing a curated selection of products that adhere to the user's color preferences.

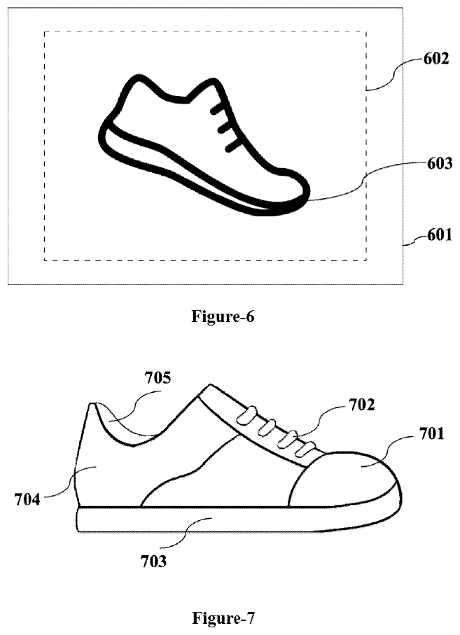

FIG. 6 depicts an exemplary line diagram of rectangular sampling method used by the product identification module to accurately identify the pixels belonging to the product under consideration. The module helps to discard any pixels that are not part of the product from the color analysis and thus essentially removes the background pixels from the image. The image boundary (601), the rectangular sample box (602) and the boundary of the extracted pixel (603) are depicted in the figure.

FIG. 7 depicts an exemplary line diagram of different parts of a sample image as identified by the part identification module. The part identification module groups the pixels based on the respective parts, identifies each part of the product as per the defined parts retrieved from the image retrieval module for the product. The part identification module uses a trained deep-learning models available for each part identification of the product. The information on which model to use for a product part is retrieved from the image retrieval module. The part identification module maps each pixel on the product to which part of the product it belongs, so that the later color extraction module can process and may group pixels for each part separately. A sample of part identification for a shoe product is shown in FIG. 7, where five parts are defined for the shoe, identified as the shoe front side (701), shoe laces (702), shoe sole (703), shoe back side (704) and the shoe inner part (705).

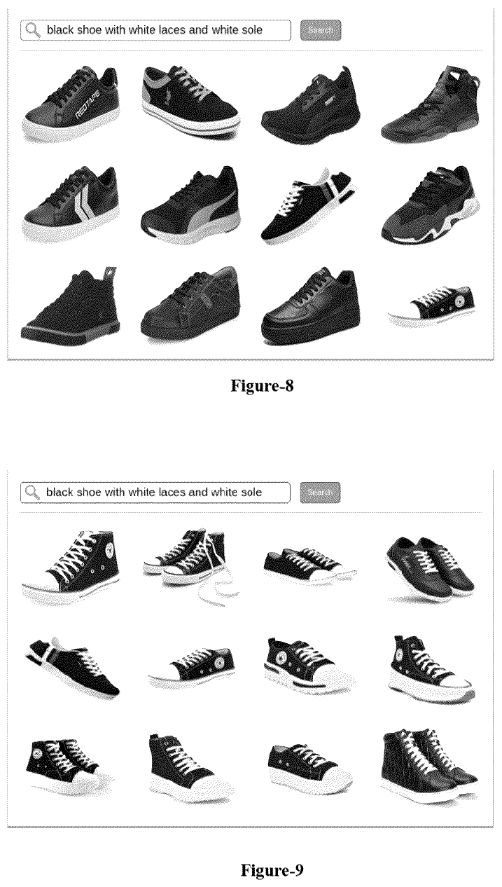

FIG. 8 depicts an exemplary image of retrieval result for an existing system that presents the output where color specifics are absent. The present system operates on textual color descriptors or implement color histograms to fetch product images, focusing primarily on the mentioned color within the text description. In case of textual color descriptors, the system retrieves a selection of products by identifying the word “black” within their textual descriptions. The approach, while straightforward, tends to overlook the nuanced visual details and patterns of color in the actual product.

FIG. 9 depicts an exemplary image of retrieval result for the proposed system, which incorporates explicit color information. The proposed system surpasses its predecessor by utilizing detailed color data from specific parts of the product, such as the shoe sole and laces. By processing this granular color information, the system achieves a more accurate and relevant retrieval of products. It demonstrates an improved capability to match the user's search intent by returning images of products that not only contain the color black but align more closely with the specific color placements queried by the user. The targeted search capability greatly enhances the user experience by enabling more accurate and refined product discovery on e-commerce platforms and marketplaces.

There are several advantages of the present invention that significantly enhance the capabilities of product search and analysis over current systems. Traditionally, color extraction has relied heavily on manual text descriptions or the utilization of color histograms, which often ignore the color distribution across different parts of a product. The invention overcomes these limitations by implementing a systematic method for the extraction of color for each individual part of the image, thus providing a more detailed and accurate color representation.

The development of a product part-wise color representation matrix offers an exact depiction of the product's color composition. This color matrix can serve multiple functions including identifying products with similar color schemes or facilitate querying an inventory of image datasets based on specific color descriptions. This adaptability makes it a valuable tool for a variety of applications including recommendation systems, product analytics, or for enhancing the accuracy of product searches.

Moreover, the proposed method enhances recommendation and analytics systems by replacing text-based color information with detailed color representation. This innovation addresses the inaccuracies caused by discrepancies between textual color descriptions and the product's actual appearance. By conducting a multi-dimensional analysis of each distinct part of a product, it delivers a nuanced and exacting approach to color-based analytics.

Additionally, the proposed invention paves the way for more sophisticated product recommendation engines. By analyzing the color matrix, the system delivers suggestions that are more aligned with consumer preferences, which can be particularly nuanced in terms of color which results in a more personalized user experience and potentially increases consumer satisfaction and engagement. The query color matrix in the recommendation engine to be updated in an iterative manner based on user feedback to improve the recommendation results over time. thereby enabling the engine to align the results based on the color preference changes of the user over the duration of his interaction with the system.

Reference numbers:

| Components | Reference Numbers |
|---|---|
| System | 100 |
| Image Retrieval Module | 101 |
| Product Identification Module | 102 |
| Part Identification Module | 103 |
| Color Extraction Module | 104 |
| Color Representation Module | 105 |
| Color Matching Module | 106 |

We claim:

1. A system for multi-color product representation via part-wise color extraction, the system (100) comprising:
a. an image retrieval module (101) configured to retrieve a product image and associated data from one or more sources of a repository, an internal storage, or a database;
b. a product identification module (102) configured to extract the product pixels of the retrieved image received from the image retrieval module (101);
c. a part identification module (103) configured to distinguish different parts of the product by mapping each pixel to the respective product part of the extracted product pixels from the product identification module (102);
d. a color extraction module (104) designed to extract each pixel of a plurality of product parts' data received from the part identification module (103);
e. a color representation module (105) configured to create a two-dimensional vector for each product part, representing the color percentages for each color in the palette, operatively connected to the color extraction module (104); and
f. a color matching module (106) configured to compare the extracted color information against a comprehensive color database to determine the closest matching colors for the plurality of product parts utilizing the color representation data from the color representation module (105).

2. The system (100) as claimed in claim 1, wherein the image retrieval module (101) is configured to retrieve text description data of the product, detailing the name, characteristics, and part definitions to guide separate color extraction for parts discernible by material or boundaries for human evaluators, further configured to covert images of the products to multiple format and dimension for subsequent color analysis.

3. The system (100) as claimed in claim 1, wherein the image retrieval module (101) is further configured to covert images of the products to multiple format and dimension for subsequent color analysis.

4. The system (100) as claimed in claim 1, wherein the product identification module (102) is configured to mark each pixel within an image individually, to ascertain its affiliation with the product, using an output of a localization deep learning module, a product description, or a rectangular sampling method, thereby facilitating the exclusion of non-product pixels for the subsequent color analysis.

5. The system (100) as claimed in claim 4, wherein the rectangular sampling method involves defining a rectangle with a smaller dimension than the image dimension and using it as a prompt for a prompt-based model for the extraction of product pixels from the image.

6. The system (100) as claimed in claim 1, wherein the part identification module (103) is designed to map each pixel of the product to a specific part by identifying individual pixel colors, aggregating similar colors based on the number of pixels sharing the same color out of the total number of pixels thereby facilitating the grouping of pixels belonging to different parts for subsequent color extraction module (104) to process and segregate pixels pertaining to each distinct part, for color analysis.

7. The system (100) as claimed in claim 1, wherein the color extraction module (104) identifies and matches the pixel colors by measuring the distance from the RGB value of the pixel to each of the RGB value of a predefined color palette from the image retrieval module (101), analyzes pixel distribution for each product part, and calculates color percentages relative to the total number of pixels for the part.

8. The system (100) as claimed in claim 1, wherein the color extraction module (104) employs distance measurement techniques including a Euclidean or an absolute distance to match each pixel's color within a part to the closest corresponding color in the defined palette.

9. The system (100) as claimed in claim 1, wherein the color matching module (106) is configured to compare the colors of different products by assessing the vector distance between their respective 2-dimensional color representation matrices produced by the color representation module (105) wherein the 2-dimensional color representation matrix includes one dimension for the defined parts of the product and another dimension for the colors on the defined color palette for the product.

10. A method for multi-color product representation via part-wise color extraction, the method (200) comprises the steps of:
a. retrieving a product image and associated data from one or more sources of a repository, an internal storage, or a database using an image retrieval module (201);
b. extracting product pixels from the retrieved product image using a product identification module (202);
c. distinguishing different parts of the product by mapping each pixel to the respective product part using a part identification module (203);
d. matching colors of the product parts with a predefined color palette and calculating color percentages for each part using a color extraction module (204);
e. creating a two-dimensional vector for each product part, representing the color percentages for each color in the palette using a color representation module (205); and
f. comparing the extracted color information against a comprehensive color database to determine the closest matching colors for the product parts utilizing the color representation data using a color matching module (206).
